(19) United States
(12) Patent Application Publication
(10) Pub. No.: US 2016/0224915 A1
(43) Pub. Date: Aug. 4, 2016

(54) ALT ASM

(71) Applicant: HCL TECHNOLOGIES LTD., Chennai, Tamilnadu (IN)

(72) Inventors: Apparao Vare Venkata, Bangalore (IN); Jitendra Babu Shivagangappa Nagaraj, Bangalore (IN); Sridhara Bangalore Rajan, Bangalore (IN); Vijayaraghavan Srinivasan, Bangalore (IN)

(73) Assignee: HCL Technologies Ltd., Chennai (IN)

(21) Appl. No.: 14/904,821

(22) PCT Filed: Jun. 20, 2014
(86) PCT No.: PCT/IN2014/000409

§ 371 Date: Jan. 13, 2016

(30) Foreign Application Priority Data
Jul. 15, 2013 (IN) 3163/CHE/2013

(51) Int. Cl. G06Q 10/06

(52) U.S. Cl. CPC G06Q 10/06312; G06Q 10/06315

(57) ABSTRACT

The embodiments herein relate to application support management and, more particularly, to improving throughput of the application support management. Various aspects of a process implemented in an organization are analyzed based on incoming tickets/demands and the process is optimized by removing associated functional redundancies.

### CROSS REFERENCE TO RELATED APPLICATIONS

The present application is a national phase application of international application no. PCT/IN2014/000409 filed on 20 Jun. 2014 which claims priority from, IN Application Number 3163/CHE/2013, filed on 15 Jul. 2013, the disclosure of which is hereby incorporated by reference herein.

### TECHNICAL FIELD

The embodiments herein relate to application support management and, more particularly, to improving throughput of the application support management.

### BACKGROUND

In any organization, stringent management policies are required to ensure proper resource management, work allocation, client management, service delivery and so on which help improve throughput of the organization in terms of cost reduction, improved quality, improved agility, simplified business, improved customer satisfaction and so on. Resource management refers to effectively managing employees so as to meet incoming requirements/demands.

One existing system for efficient organizational management to improve throughput of the organization is LEAN principles. In the LEAN production practice, expenditure of resources other than for creation of value for customer is considered as wastage of resources and the mechanism provides means for eliminating resource wastage. In addition to eliminating wastage, the LEAN principles also focuses on amplifying learning, fast delivery of products and services, empowering team, building integrity and so on.

LEAN practice focuses on preserving value with less work. LEAN practice defines “value” as any action or process that a customer would be willing to pay for. However, issue with the current LEAN practices is that current LEAN principles as such provides less efficiency with changes in organizational structures, requirements and so on.

Hence, there is a need for a system which can transform the LEAN production practice to be suitable for the changing organizational structures and to improve efficiency of the system.

### SUMMARY

In view of the foregoing, an embodiment herein provides system for improving throughput of an application support management process using LEAN principles in an organization, the system configured for performing right sizing of the process using a right sizing module, wherein rightsizing further comprises of performing at least one of a demand versus capacity analysis, time motion analysis and dynamic shift planning; standardizing the process and identifying changes required, using a standardization module, wherein the standardization further comprises performing at least one of a process identification, decision making, providing a dispatcher role and an error correction; executing the identified changes on the process using means provided by at least one of a plurality automation tools; executing performance management using a performance management module, wherein the performance management further comprises performing at least one of a variability analysis and a performance enhancement; executing proactive and predictive delivery of services in the organization based on the standardized process using a proactive and predictive delivery module, wherein the proactive and predictive delivery further comprises performing analysis of the process for issues, prediction of upcoming requirements and proactive management of the requirements using the process; and optimizing the process using a transformation module.

Embodiments further disclose a method for improving throughput of an application support management process using LEAN principles in an organization, the method comprises performing right sizing of the process, wherein rightsizing further comprises of performing at least one of a demand versus capacity analysis, time motion analysis and dynamic shift planning; standardizing the process and identifying changes required, wherein the standardization further comprises performing at least one of a process identification, decision making, providing a dispatcher role and an error correction; executing the identified changes on the process; executing performance management, wherein the performance management further comprises performing at least one of a variability analysis and a performance enhancement; executing proactive and predictive delivery of services in the organization based on the standardized process, wherein the proactive and predictive delivery further comprises performing analysis of the process for issues, prediction of upcoming requirements and proactive management of the requirements using the process; and optimizing the process.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of the application support & maintenance system, as disclosed in the embodiments herein;

FIG. 2 illustrates a block diagram that shows various components of the right sizing module, as disclosed in the embodiments herein;

FIG. 3 illustrates a block diagram that shows various components of the standardization module, as disclosed in the embodiments herein;

FIG. 4 illustrates a block diagram that shows various components of the performance management module, as disclosed in the embodiments herein;

FIG. 5 illustrates a block diagram that shows various components of the proactive and predictive delivery module, as disclosed in the embodiments herein;

FIG. 6 illustrates a block diagram that shows various components of the transformation module, as disclosed in the embodiments herein; and

FIG. 7 illustrates a flow diagram that shows various phases involved in the process of providing application support using the application support & maintenance system, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

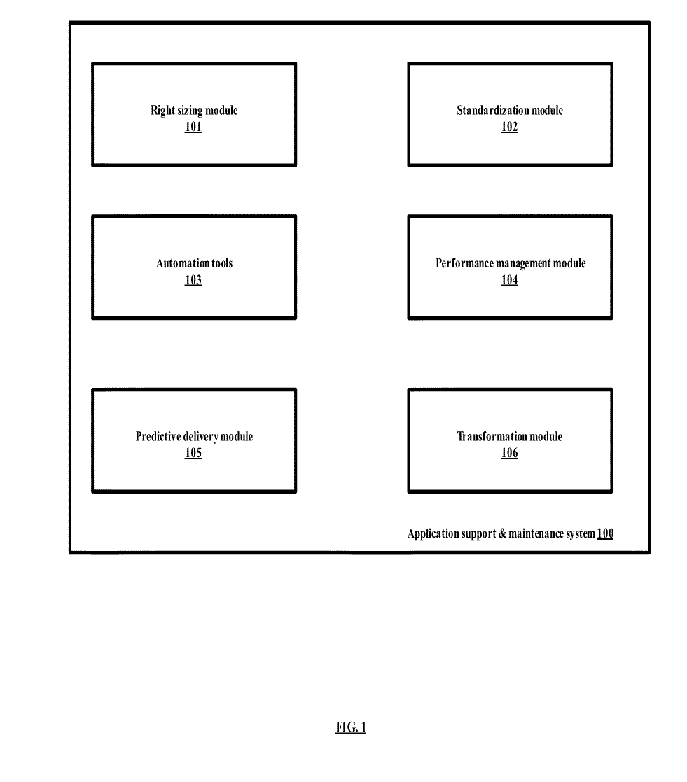

The embodiments herein disclose a process of improving throughput of organization by using a LEAN principle based Application support and maintenance system. Referring now to the drawings, and more particularly to FIGS. 1 through 7, where similar reference characters denote corresponding features consistently throughout the figures, there are shown embodiments.

FIG. 1 illustrates a block diagram of the application support & maintenance system, as disclosed in the embodiments herein. The application support & maintenance system further comprises a right sizing module 101, a standardization module 102, automation tools 103, performance management module 104, predictive delivery module 105 and a transformation module 106. Inputs to the application support & maintenance system 100 are tickets and fixed set of tasks. For example, tickets of service requests, incidents and problem requests and so on may be provided as input to the system.

The input tickets are fetched by the right sizing module 101. The right sizing module 101 initially performs a Demand Vs Capacity analysis during which the system analyzes whether enough resources are available to manage an incoming demand. For example, in an organization demand Vs capacity analysis refers to a process in which the system may check whether the organization has enough man power to manage incoming demands i.e. projects. By doing the demand Vs capacity analysis, resource requirements may be identified. In a preferred embodiment, data such as number of resources available, demand that can be managed by each resource and so on may have to be pre-configured with the right sizing module 101.

Further, the right sizing module 101 performs a time and motion analysis during which the system checks whether there is a right allocation of time by comparing working hours with a demand incoming time. For example, assume that the office hour starts at 9 AM and ends at 6 PM IST. Assume that an employee or a team works for UK clients. In this case, the UK clients come online at around 2 PM IST. That means the team may get project only by noon and half of their working time is not utilized properly. These data may be assessed using the time and motion analysis.

Further, based on the data analyzed during the demand Vs capacity analysis and the time and motion analysis, the right sizing module 101 performs a dynamic shift planning and designs a Just In Time (JIT) model during which efficient work and time allotment is planned for each team/employee according to the demands of the organization and incoming work flow. For example, if there are 2 teams namely A and B in the company and if team A's work load is more on a particular day, the JIT model may be designed in such a way that more resources are provided to team A by using resources in team B. This brings in flexibility to the organization in terms of work deployment and resource utilization; thereby increasing throughput and efficiency of the organization.

The standardization module 102 fetches selected data from output of the right sizing module 101 and other required data directly from the user as inputs for performing standardization of the process. The standardization module 102, by processing the input data, identifies the set of processes required to perform an incident management process, a problem management process, a chain management process and so on and generates a value stream map separately for each of these processes indicating how these processes are being carried out by a resource. This analysis is referred/termed to as a day in a life of an engineer. From a resource (say an engineer) perspective “day in a life of an engineer ” may refer to a number of steps being carried out by that resource so as to achieve a specific task. This analysis may take into account time taken by that resource to carry out each step separately; say for incident management process how much time the resource takes for incident login, checking against non error database, to respond to the customer with solution, resolving issue, updating knowledge database and so on. This may help the system to analyze efficiency of the process being implemented in the organization.

Based on the analysis performed by the standardization module 102, decision (s) may be made as to how the roles and responsibilities may be allocated among available resources. For example, assume one employee (resource) is working on multiple processes such as problem management, incident management and so on. This may overload the employee and ultimately reduce efficiency. If each of these processes is assigned to different resources, each resource may get more time to complete the task; thereby improving quality of the work and efficiency of the overall process. This may be done in such a way that the process is aligned towards the business needs.

Another strategy implemented as a part of the standardization process is of a dispatcher role. The dispatcher may act as a single process of queue management which considers knowledge and availability of resources so as to allocate processes. For example, assume that there are 3 resources in the organization namely A, B and C. When a ticket corresponding to a new process is received, the dispatcher checks which resources are available at that moment. If resources B & Care available, the dispatcher; based on preconfigured roles and responsibilities of the resources, decides whom the ticket has to be assigned. This may further ensure that each of the incoming tickets is assigned to right resources and that none of the tickets go unattended. The dispatcher role may be implemented as a part of business unit of customers.

Another component that may be implemented as a part of the customer business unit/target operating module may be a L1.5 layer which is used to resolve tickets using a non error database. In this process, when a ticket is received, the L1.5 layer checks pattern of the ticket and checks for same pattern in the non error database and when a match is found, the ticket is resolved considering the match. In an embodiment, incoming tickets are segregated based on complexity levels and lesser complexity type tickets are assigned to the L1.5 layer. The complexity of a ticket may be measured/determined on an engagement level. In a preferred embodiment, data regarding standard operating procedures maintained in an associated database also is considered while deciding execution strategies for a ticket. Further, based on number of resources allocated to complete a specific process and amount of time taken to complete the process, cost incurred and efficiency may also be measured. Based on all these parameters, each task may be standardized to improve efficiency of the process. In another preferred embodiment, the analysis carried out by the right sizing module 101 and the standardization module 102 helps to identify value added and non-value added services/processes from the customer's perspective. Further, the customer may be provided with information on certain services that are value added, essential but non-value added and so on. Further, steps may be taken so as to ensure that need for repetition of non-value added services are eliminated. For example, assume that 2 new tickets from same customer correspond to similar activities which require processing of same non value added services. In this case, this issue may be communicated with the customer and reports for these two tickets may be clubbed in such a way that processing of similar non-value added services are done only once. In an embodiment, the requirements are customer specific. This may further help to reduce cost incurred and efforts required.

Further, based on this analysis, decision may be made on whether certain processes/activities may be relocated to any other layer. For example, consider the banking process in which the customer had to walk into the bank for any banking related services a few years back. Now, most of the banking services are moved to a different service layer so that the customer can access services using web or mobile services.

The automation tools set 103 possesses set of tools that are required to change the process as decided during the standardization process. The tools may refer to automation tools which may be used to automate certain processes.

The performance management module 104 focuses on development of skills of individuals/resources. A variability analysis is performed during which performance level of each resource is measured and compared to see who is more efficient. The efficiency from this perspective may vary depending on parameters such as complexity of work/process being handled by each resource and so on. This analysis may take into account types of processes/tickets being handled, skill set required to handle each process and so on. Based on analysis, a benchmark is set in terms of performance and skills of other resources are compared with the set standard to identify and measure a skill gap. Further, measures are taken to reduce the skill gap and to improve skills of individual resources and thereby improve efficiency. One means to reduce skill gap could be identifying cross skilled resources and utilizing them effectively. A suitable tracking mechanism is used to track and employ necessary means for continuous skill updation of resources. A huddle process may be employed to assess over a time period, what is efficiency of a resource, how performance gap may be filled, what is support required to resolve pending tickets which also involves a periodic goal setting and improvement tracking means.

The proactive and predictive delivery module 105 considers various parameters such as running tickets, repeated tickets, and resolved tickets and so on and identifies whether there are any issues associated with the system that is affecting overall performance of the system. For example, there may be certain issues that are continuously occurring, certain issues that comes once in a while (rarities) and so on. Upon identifying such issues, the proactive and predictive delivery module 105 proactively checks whether these issues may be eliminated. This in turn may increase stability of the system. The system predicts and proactively takes necessary steps to manage any upcoming requirements. The proactive management helps to design the system with proper skill index required to manage any number of incoming tickets. So as to improve efficiency of the proactive management, the proactive and predictive delivery module 105 performs a what-if analysis to identify what happens to other processes if one process goes down, how this affects performance of the system as a whole and so on. Upon identifying these issues, resources who are in charge of other processes may be notified and informed that their processes may not work as these processes are interdependent.

The transformation module 106 provides means to optimize the business process by removing/eliminating any sort of functional redundancies in the process. This may consider parameters such as application portfolio, overlapping processes, different installations that may be virtualized, applications having similar functionality that may be combined and so on. The transformation may vary from one customer to other depending on their requirements and functional landscapes.

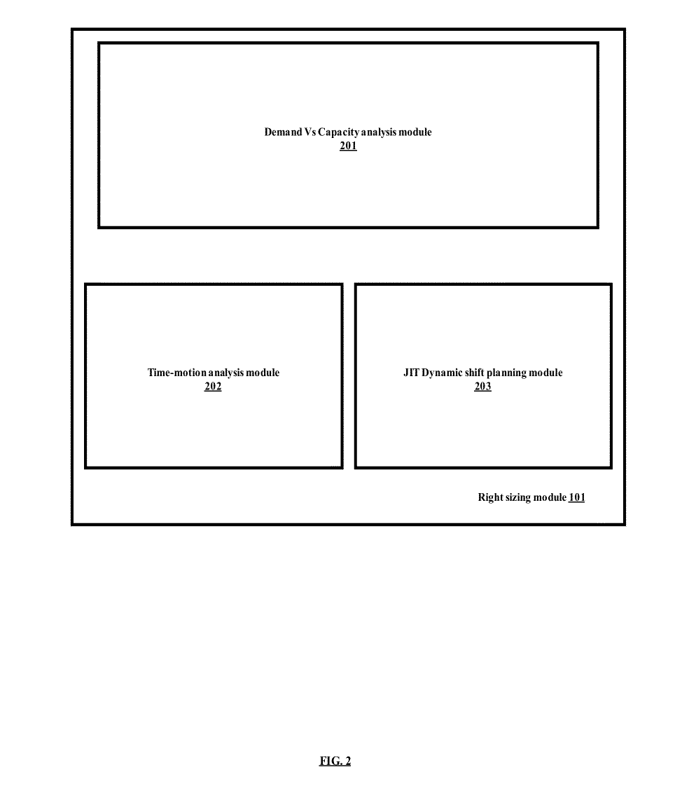

FIG. 2 illustrates a block diagram that shows various components of the right sizing module, as disclosed in the embodiments herein. The input tickets are fetched by the right sizing module 101. The right sizing module 101 further comprises a demand vs. capacity analysis module 201, a time-motion analysis module 202, and a Just In Time (JIT) dynamic shift planning module 203. The demand vs. capacity analysis module 201 in the right sizing module 101 initially performs a Demand Vs Capacity analysis during which the system analyzes whether enough resources are available to manage an incoming demand. For example, in an organization demand Vs capacity analysis refers to a process in which the system may check whether the organization has enough man power to manage incoming demands i.e. projects. By doing the demand Vs capacity analysis, resource requirements may be identified. In a preferred embodiment, data such as number of resources available, demand that can be managed by each resource and so on may have to be pre-configured with the right sizing module 101.

Further, the time-motion analysis module 202 in the right sizing module 101 performs a time and motion analysis during which the system checks whether there is a right allocation of time. For example, assume that the office hour starts at 9 AM and ends at 6 PM IST. Assume that an employee or a team works for UK clients. In this case, the UK clients come online at around 2 PM IST. That means the team may get project only by noon and half of their working time is not utilized properly. These data may be assessed using the time and motion analysis.

Further, based on the data analyzed during the demand Vs capacity analysis and the time and motion analysis, the JIT dynamic shift planning module 203 in the right sizing module 101 performs a dynamic shift planning and designs a Just In Time (JIT) model during which efficient work and time allotment is planned for each team/employee according to the demands of the organization and incoming work flow. For example, if there are 2 teams namely A and B in the company and if team A's work load is more on a particular day, the JIT model may be designed in such a way that more resources are provided to team A by using resources in team B. This brings in flexibility to the organization in terms of work deployment and resource utilization; thereby increasing throughput and efficiency of the organization.

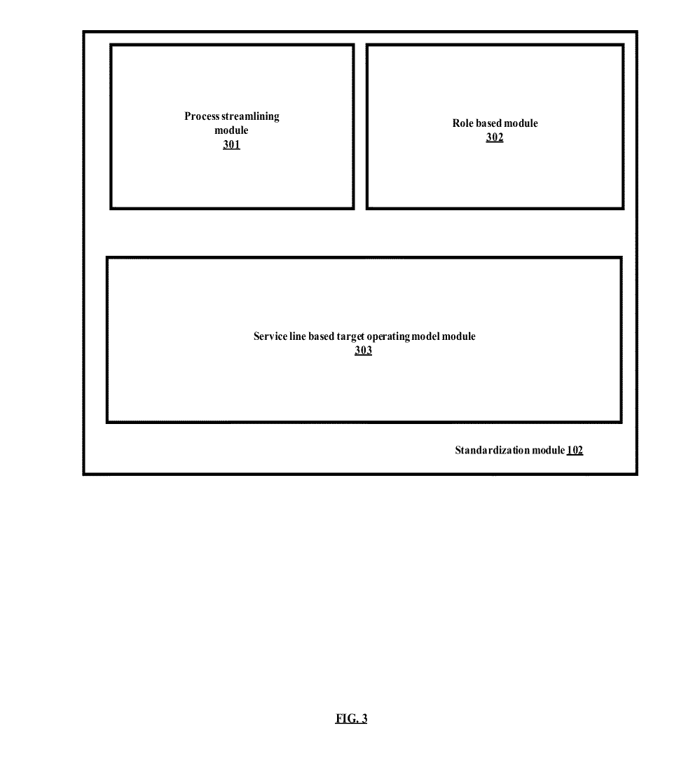

FIG. 3 illustrates a block diagram that shows various components of the standardization module, as disclosed in the embodiments herein. The standardization module 102 fetches selected data from output of the right sizing module 101 and other required data directly from the user as inputs for performing standardization of the process. The standardization module 102 further comprises a process streamlining module 301, a role based module 302, and a service line based target operating model module 303. The process streamlining module 301 in the standardization module 102, processes the input data, identifies the set of processes required to perform an incident management process, a problem management process, a chain management process and so on and generates a value stream map separately for each of these processes indicating how these processes are being carried out by a resource. This analysis is referred/termed to as a day in a life of an engineer. From a resource (say an engineer) perspective “day in a life of an engineer” may refer to a number of steps being carried out by that resource so as to achieve a specific task. This analysis may take into account time taken by that resource to carry out each step separately; say for incident management process how much time the resource takes for incident login, checking against non error database, to respond to the customer with solution, resolving issue, updating knowledge database and so on. This may help the system to analyze efficiency of the process being implemented in the organization.

Based on the analysis performed by the process streamlining module 301, the role based module 302 makes decision (s) as to how the roles and responsibilities may be allocated among available resources. For example, assume one employee (resource) is working on multiple processes such as problem management, incident management and so on. This may overload the employee and ultimately reduce efficiency. If each of these processes is assigned to different resources, each resource may get more time to complete the task; thereby improving quality of the work and efficiency of the overall process. This may be done in such a way that the process is aligned towards the business needs.

Another strategy implemented as a part of the standardization process is of a dispatcher role. The service line based target operating model module 303 may act as a single process of queue management which considers knowledge and availability of resources so as to allocate processes. For example, assume that there are 3 resources in the organization namely A, B and C. When a ticket corresponding to a new process is received, the service line based target operating model module 303 checks which resources are available at that moment. If resources B & Care available, the service line based target operating model module 303; based on preconfigured roles and responsibilities of the resources, decides whom the ticket has to be assigned. This may further ensure that each of the incoming tickets is assigned to right resources and that none of the tickets go unattended. The dispatcher role may be implemented as a part of business unit of customers.

Further, as a part of the dispatcher role, a L1.5 layer also may be implemented in the customer business unit/target operating module and is used to resolve tickets using a non error database. In this process, when a ticket is received, the L1.5 layer checks pattern of the ticket and checks for same pattern in the non error database and when a match is found, the ticket is resolved considering resolving strategies associated with the match found corresponding to each incoming ticket. In an embodiment, incoming tickets are segregated based on complexity levels and lesser complexity type tickets are assigned to the L1.5 layer. The complexity of a ticket may be measured/determined on an engagement level. In a preferred embodiment, data regarding standard operating procedures maintained in an associated database also is considered while deciding execution strategies for a ticket. Further, based on number of resources allocated to complete a specific process and amount of time taken to complete the process, cost incurred and efficiency may also be measured. Based on all these parameters, each task may be standardized to improve efficiency of the process. In another preferred embodiment, the analysis carried out by the right sizing module 101 and the standardization module 102 helps to identify value added and non-value added services/processes from the customer's perspective. Further, the customer may be provided with information on certain services that are value added, essential but non-value added and so on. Further, steps may be taken so as to ensure that need for repetition of non-value added services are eliminated. For example, assume that 2 new tickets from same customer correspond to similar activities which require processing of same non value added services. In this case, this issue may be communicated with the customer and reports for these two tickets may be clubbed in such a way that processing of similar non-value added services are done only once. In an embodiment, the requirements are customer specific. This may further help to reduce cost incurred and efforts required.

Further, based on this analysis, decision may be made on whether certain processes/activities may be relocated to any other layer. For example, consider the banking process in which the customer had to walk into the bank for any banking related services a few years back. Now, most of the banking services are moved to a different service layer so that the customer can access services using web or mobile services.

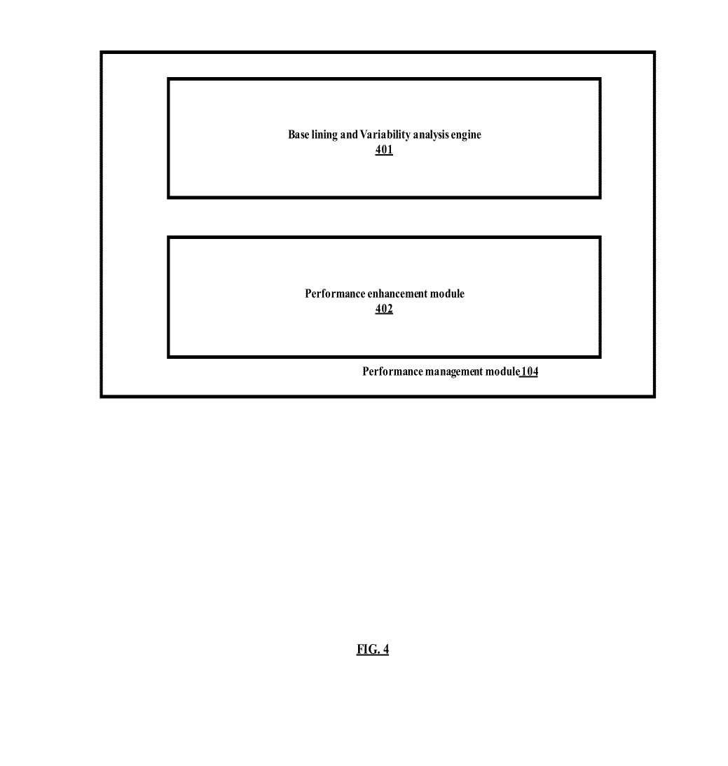

FIG. 4 illustrates a block diagram that shows various components of the performance management module, as disclosed in the embodiments herein. The performance management module 104 further comprises of a base lining and variability analysis engine 401 and a performance enhancement module 402 and it focuses on development of skills of individuals/resources. The base lining and variability analysis engine 401 performs a variability analysis during which performance level of each resource is measured and compared to see who is more efficient. The efficiency from this perspective may vary depending on parameters such as complexity of work/process being handled by each resource and so on. The base lining and variability analysis engine 401 may take into account types of processes/tickets being handled, skill set required to handle each process and so on during the variability analysis. The performance enhancement module 402, based on analysis performed by the base lining and variability analysis engine 401, sets a benchmark in terms of performance and skills of resources and compares performance and skills of resources with the set bench mark/standard to identify and measure a skill gap. Further, the performance enhancement module 402 takes measures to reduce the skill gap and to improve skills of individual resources and thereby improve efficiency. One means to reduce skill gap could be identifying cross skilled resources and utilizing them effectively. A suitable tracking mechanism is used to track and employ necessary means for continuous skill updation of resources. A huddle process may be employed to assess over a time period, what is efficiency of a resource, how performance gap may be filled, what is support required to resolve pending tickets which also involves a periodic goal setting and improvement tracking means.

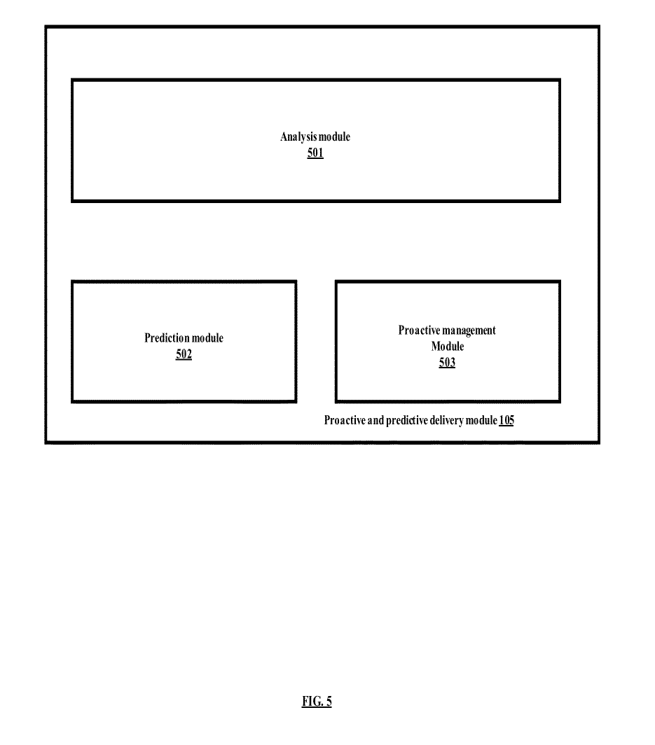

FIG. 5 illustrates a block diagram that shows various components of the proactive and predictive delivery module, as disclosed in the embodiments herein. The proactive and predictive delivery module 105 further comprises of an issue detection module 501, a prediction module 502, and a proactive management module 503. The detection module 501 considers and analyzes various parameters such as running tickets, repeated tickets, and resolved tickets and so on and identifies whether there are any issues associated with the system that is affecting overall performance of the system/process implemented. For example, there may be certain issues that are continuously occurring, certain issues that comes once in a while (rarities) and so on. Upon identifying such issues, the prediction module 502 proactively checks whether these issues may be eliminated. This in turn may increase stability of the system. The prediction module 502 further predicts and proactively takes necessary steps to manage any upcoming requirements. The proactive management module 503 helps to design the system with proper skill index required to manage any number of incoming tickets. So as to improve efficiency of the proactive management, the proactive management module 503 performs a what-if analysis to identify what happens to other processes if one process goes down, how this affects performance of the system as a whole and so on. Upon identifying these issues, resources who are in charge of other processes may be notified and informed that their processes may not work as these processes are interdependent.

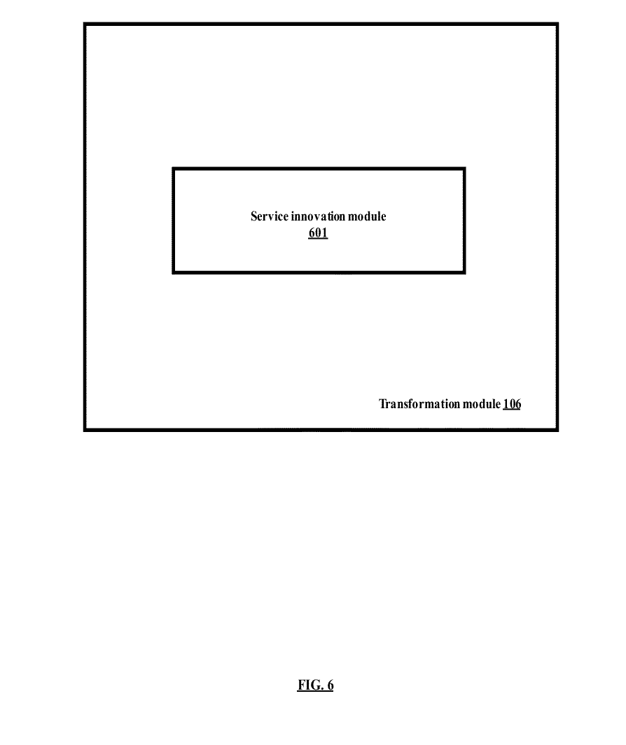

FIG. 6 illustrates a block diagram that shows various components of the transformation module, as disclosed in the embodiments herein. The transformation module 106 further comprises of a service innovation module 601 and provides means to optimize the business process by removing/eliminating any sort of functional redundancies in the process. The service innovation module 601 may consider parameters such as application portfolio, overlapping processes, different installations that may be virtualized, applications having similar functionality that may be combined and so on. The transformation may vary from one customer to other depending on their requirements and functional landscapes.

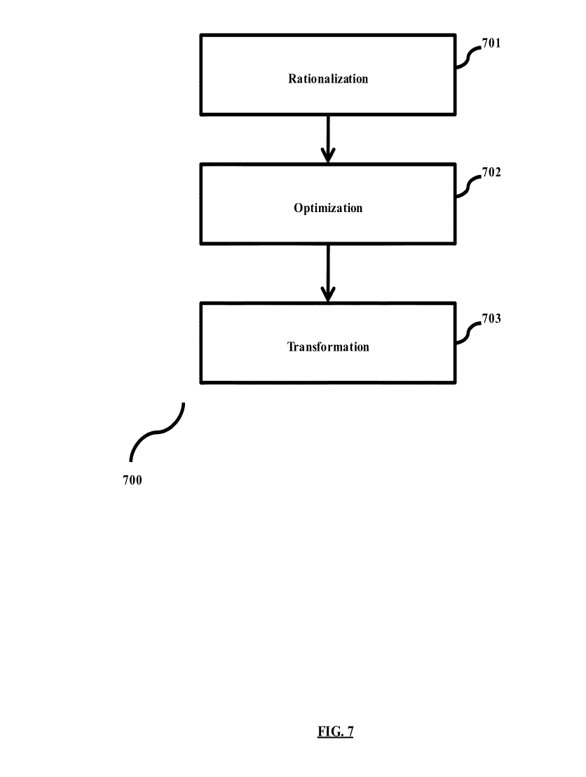

FIG. 7 illustrates a flow diagram that shows various phases involved in the process of providing application support using the application support & maintenance system, as disclosed in the embodiments herein. The application support using the application support & maintenance system involves three phases namely rationalization phase, optimization phase and transformation phase.

Inputs to the application support & maintenance system 100 are tickets related to service requests, incidents, problem requests and so on along with fixed set of tasks. The rationalization phase (701) focuses on waste removal and achieving service maturity. The rationalization phase further involves two processes namely right sizing and standardization. Right sizing involves performing Demand Vs Capacity analysis and Time Vs Motion study to analyze how the available resources are managing the requirements and incoming tickets. Further the right sizing module 101 in the application support & maintenance system 100 performs a Just In Time (JIT) analysis during which efficient work and time allotment is planned for each resource/team based on demands of the organization and incoming work flow. The right sizing is performed to bring flexibility in terms of work deployment and resource utilization thereby increasing throughput of the organization.

Further, in the standardization process, the standardization module 102 in the application support & maintenance system 100 identifies a set of processes required to perform any of incident management, problem management and/or chain management processes and generates a value stream map for each process. The value stream map indicates how each resource carries out each of the processes. Further, based on the data inferred the standardization module 102 designs “a day in life of an engineer” which indicates number of steps being carried out by each resource so as to achieve a specific task. The standardization module 102 further makes decisions on how roles and responsibilities are to be allocated among available resources. A dispatcher role is also introduced which acts as a single process for queue management to allocate processes considering knowledge and availability of resources. A L1.5 layer is also designed which is used to resolve tickets using a non error database.

Further, considering all parameters, the standardization module 102 standardizes each task in such a way that efficiency of the process is improved. The standardization process further involves identifying and categorizing processes as value added, non value added, and essential but non value added and so on. Further, measures are taken so as to remove/eliminate use or repetition of non value added services. The standardization also involves taking decision on whether certain processes can be relocated to a different layer to improve efficiency of the process. The various strategies may be implemented using suitable means provided in the automation tool set 103.

Further in the optimization phase (702), the application support & maintenance system 100 focuses on improving value and in delivery of service excellence. The optimization phase involves two processes namely performance management and proactive& predictive delivery. The performance management focuses on development of skills of resources. So as to analyze performance of various resources in the organization, the performance management module 104 in the application support & maintenance system 100 performs a variability analysis during which skill gap of each resource is identified by comparing with specific benchmarks. The performance is analyzed by considering various parameters such as type of process/ticket being handled by each resource, skill set required to handle each task and so on. After identifying/measuring skill gap of resources, means for identifying skill gap of resources is also identified. Periodic goal setting and improvement analysis is also done in the performance management process.

The predictive and proactive delivery identifies possible occurrence of any issue that may affect performance of the process and checks if issues can be eliminated. This may further improve stability of the process and also helps to design the system with proper skill index to manage any number of incoming tickets at any point of time in future.

Further, in the transformation process (703) provides means to optimize the business process by removing/eliminating any sort of functional redundancies in the process. This may consider parameters such as application portfolio, overlapping processes, different installations that may be virtualized, applications having similar functionality that may be combined and so on. The transformation may vary from one customer to other depending on their requirements and functional landscapes. The various actions in method 700 may be performed in the order presented, in a different order or simultaneously. Further, in some embodiments, some actions listed in FIG. 7 may be omitted.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a system for application support management. The mechanism allows LEAN principles based application support management, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A system for improving throughput of an application support management process using LEAN principles in an organization, said system configured for:
performing right sizing of said process using a right sizing module, wherein rightsizing further comprises of performing at least one of a demand versus capacity analysis, time motion analysis and a Just In Time (JIT) dynamic shift planning;
standardizing said process and identifying changes required, using a standardization module, wherein said standardization further comprises performing at least one of a process identification, decision making, providing a dispatcher role and an error correction;
executing said identified changes on said process using means provided by at least one of a plurality automation tools;
executing performance management using a performance management module, wherein said performance management further comprises performing at least one of a variability analysis and a performance enhancement;
executing proactive and predictive delivery of services in said organization based on said standardized process using a proactive and predictive delivery module, wherein said proactive and predictive delivery further comprises performing analysis of said process for issues, prediction of upcoming requirements and proactive management of said requirements using said process; and
optimizing said process using a transformation module.

2. The system as in claim 1, wherein said right sizing module is further configured to perform said demand versus capacity analysis using a demand versus capacity analysis module by comparing incoming demand of said organization with available resources, wherein said incoming demand is tickets related to at least one of service requests, incidents and problem requests.

3. The system as in claim 1, wherein said right sizing module is further configured to perform said time versus motion analysis using a time motion analysis module by comparing working hours of resources in said organization with a demand incoming time.

4. The system as in claim 1, wherein said right sizing module is further configured to perform said dynamic shift planning using a JIT dynamic shift planning module by designing a Just In Time (JIT) model, wherein said designing JIT model further comprises planning efficient work and time allotment for each resource or group of resources based on demands of said organization and incoming work flow.

5. The system as in claim 1, wherein said standardization module is further configured to perform said process identification by:
identifying a set of processes required to perform at least one of an incident management process, a problem management process or a chain management process, using a process streamlining module;
generating a value stream map for each of said incident management process, problem management process and chain management process, wherein said value stream map indicates how each of said processes are being carried out by each of a plurality of resources in said organization using said process streamlining module;
identifying number of steps being carried out by each of said plurality of resources so as to achieve a specific task using said process streamlining module;
deciding allocation of roles and responsibilities among said plurality of resources using a role based module;
implementing means for queue management using a service line based target operating model module;
resolving each of a plurality of incoming tickets using a non-error database; and
identifying a plurality of value added and non value added services and eliminating repetition of said non value added services.

6. The standardization module as in claim 5, wherein said service line based target operating model module is further configured to implement said queue management by:
receiving at least one of said plurality of incoming tickets;
identifying available resources in said organization;
selecting at least one resource by analyzing pre-configured roles and responsibilities of said identified resources; and
assigning said incoming ticket said selected at least one resource.

7. The standardization module as in claim 5 is further configured to resolve each of a plurality of incoming tickets by:
identifying pattern of each of said plurality of incoming tickets;
comparing said identified pattern with said non-error database, wherein said non-error database comprises information on pattern of tickets and corresponding resolving strategies;
finding match for pattern of each of said plurality of incoming tickets in said non-error database; and
selecting resolving strategies corresponding to said identified match; and
resolving each of said plurality of incoming tickets using corresponding resolving strategies selected.

8. The system as in claim 1, wherein said performance management module is further configured to perform said variability analysis by:
measuring performance level of a plurality of resources in said organization using a base lining and variability analysis engine;
setting benchmark in terms of skills and resources of resources using said base lining and variability analysis engine;
identifying skill gap between resources, wherein said identifying skill gap comprises comparing skills of each of said plurality of resources with set benchmark using said base lining and variability analysis engine; and
providing means to identify said identified skill gap using a performance enhancement module.

9. The system as in claim 1, wherein said proactive and predictive delivery module is further configured to perform said analysis of process for issues by analyzing at least one of a plurality of as running tickets, repeated tickets or resolved tickets using an analysis module.

10. The system as in claim 1, wherein said proactive and predictive delivery module is further configured to perform said proactive management of resources by designing said process with proper skill index required to manage a plurality of upcoming requirements using a proactive management module.

11. The system as in claim 1, wherein said transformation module is configured to perform said optimization of process by removing functional redundancies in said process using a service innovation module.

12. A method for improving throughput of an application support management process using LEAN principles in an organization, said method comprises:
performing right sizing of said process, wherein rightsizing further comprises of performing at least one of a demand versus capacity analysis, time motion analysis and dynamic shift planning;
standardizing said process and identifying changes required, wherein said standardization further comprises performing at least one of a process identification, decision making, providing a dispatcher role and an error correction;
executing said identified changes on said process;
executing performance management, wherein said performance management further comprises performing at least one of a variability analysis and a performance enhancement;
executing proactive and predictive delivery of services in said organization based on said standardized process, wherein said proactive and predictive delivery further comprises performing analysis of said process for issues, prediction of upcoming requirements and proactive management of said requirements using said process; and
optimizing said process.

13. The method as in claim 12, wherein said performing demand versus capacity analysis further comprises comparing incoming demand of said organization with available resources, wherein said incoming demand is tickets related to at least one of service requests, incidents and problem requests.

14. The method as in claim 12, wherein said time motion analysis further comprises comparing working hours of resources in said organization with a demand incoming time.

15. The method as in claim 12, wherein said dynamic shift planning further comprises designing a Just In Time (JIT) model, wherein said designing JIT model further comprises planning efficient work and time allotment for each resource or group of resources based on demands of said organization and incoming work flow.

16. The method as in claim 12, wherein said process identification further comprises:
identifying a set of processes required to perform at least one of an incident management process, a problem management process or a chain management process;
generating a value stream map for each of said incident management process, problem management process and chain management process, wherein said value stream map indicates how each of said processes are being carried out by each of a plurality of resources in said organization;
identifying number of steps being carried out by each of said plurality of resources so as to achieve a specific task;
deciding allocation of roles and responsibilities among said plurality of resources;
implementing means for queue management using a dispatcher role;
resolving each of a plurality of incoming tickets using a non-error database; and
identifying a plurality of value added and non value added services and eliminating repetition of said non value added services.

17. The method as in claim 16, wherein said implementing queue management using said dispatcher role further comprises:
receiving at least one of said plurality of incoming tickets;
identifying available resources in said organization;
selecting at least one resource by analyzing pre-configured roles and responsibilities of said identified resources; and
assigning said incoming ticket said selected at least one resource.

18. The method as in claim 16, wherein said resolving each of said plurality of incoming tickets further comprises:
identifying pattern of each of said plurality of incoming tickets;
comparing said identified pattern with a database, wherein said database comprises information on pattern of tickets and corresponding resolving strategies;
finding match for pattern of each of said plurality of incoming tickets in said database; and
selecting resolving strategies corresponding to said identified match; and
resolving each of said plurality of incoming tickets using corresponding resolving strategies selected.

19. The method as in claim 12, wherein said variability analysis further comprises:
measuring performance level of a plurality of resources in said organization;
setting benchmark in terms of skills and resources of resources;
identifying skill gap between resources, wherein said identifying skill gap comprises comparing skills of each of said plurality of resources with set benchmark; and
providing means to identify said identified skill gap.

20. The method as in claim 12, wherein said analysis of process for issues further comprises analyzing at least one of a plurality of as running tickets, repeated tickets or resolved tickets using an analysis module.

21. The method as in claim 12, wherein said proactive management of resources further comprises designing said process with proper skill index required to manage a plurality of upcoming requirements.

22. The method as in claim 12, wherein said optimization of process further comprises removing functional redundancies in said process.
